(19) United States
(12) Patent Application Publication
(10) Pub. No.: US 2020/0361181 A1
(43) Pub. Date: Nov. 19, 2020

(54) LAMINATE AND ITS PRODUCTION METHOD, AND MOLDED PRODUCT AND ITS PRODUCTION METHOD

(71) Applicant: AGC Inc., Chiyoda-ku (JP)

(72) Inventors: Tomoya Hosoda, Chiyoda-ku (JP); Norio Ozawa, Chiyoda-ku (JP); Takashi Sato, Chiyoda-ku (JP)

(73) Assignee: AGC Inc., Chiyoda-ku (JP)

(21) Appl. No.: 16/984,401

(22) Filed: Aug. 4, 2020

Related U.S. Application Data
(63) Continuation of application No. PCT/JP2019/006612, filed on Feb. 21, 2019.

(30) Foreign Application Priority Data
Feb. 23, 2018 (JP) 2018-030922
May 29, 2018 (JP) 2018-102664
Sep. 5, 2018 (JP) 2018-166293

(51) Int. Cl. B32B 15/08; C09D 127/12; C09D 5/03; B32B 27/08; B32B 27/18; B32B 7/04; B05D 1/12; B32B 27/38

(52) U.S. Cl. CPC B32B 15/08; C09D 127/12; C09D 5/035; B32B 27/08; B32B 27/18; B32B 2305/72; B05D 1/12; B32B 27/38; B32B 2255/06; B32B 2255/26; B32B 2307/584; B32B 7/04

(57) ABSTRACT

To provide a method for producing a laminate, capable of forming a coating film excellent in abrasion resistance by using a fluororesin powder, and capable of suppressing foaming when the coating film is formed by using the fluororesin powder.

A method for producing a laminate 10 comprising a substrate 12 and a coating film 14 formed on a surface of the substrate 12, which comprises applying the following powder composition to the surface of the substrate 12 to form the coating film 14.

Powder composition: A powder composition comprising a fluororesin powder formed of a resin material containing as the main component a melt-moldable fluororesin which has a carbonyl group-containing group or the like, and having D50 of from 0.01 to 100 μm, and a non-fluororesin powder formed of a resin material containing as the main component a non-fluororesin such as a polyarylketone, and having D50 of from 0.01 to 100 μm, in a specific volume proportion.

### TECHNICAL FIELD

The present invention relates to a laminate and its production method, and a molded product and its production method.

### BACKGROUND ART

It has been known to form a coating film on the surface of a substrate by using a fluororesin powder (Patent Document 1). However, a coating film formed by using a fluororesin powder is insufficient in abrasion resistance. Further, when a coating film is formed by using a fluororesin powder excellent in adhesion to a substrate, the coating film is likely to foam.

To improve abrasion resistance of a molded product of a fluororesin, a method of incorporating an engineering plastic with a fluororesin, followed by melt-kneading to form a resin composition, and molding the composition has been proposed (Patent Documents 2 and 3).

### PRIOR ART DOCUMENTS

### Patent Documents

Patent Document 1: WO2017/111102

Patent Document 2: Japanese Patent No. 4661205

Patent Document 3: WO2013/125468

### DISCLOSURE OF INVENTION

### Technical Problem

However, when a kneaded product obtained by incorporating an engineering plastic with a fluororesin, followed by melt-kneading, is ground, the resin composition is fibrillated. Accordingly, it is difficult to produce a powder comprising a resin composition containing a fluororesin and an engineering plastic.

Further, in a molded product obtained by molding a resin composition obtained by incorporating an engineering plastic with a fluororesin, followed by melt-kneading, the dispersed particle size of the engineering plastic dispersed in the molded product is small, whereby no sufficient effect to improve abrasion resistance by the engineering plastic may be obtained.

The present invention provides a method for producing a laminate, capable of forming a coating film excellent in abrasion resistance by using a fluororesin powder and capable of suppressing foaming when the coating film is formed by using the fluororesin powder, a laminate having a coating film containing a fluororesin, excellent in abrasion resistance and having foaming suppressed, a method for producing a molded product, capable of forming a molded product excellent in abrasion resistance by using a fluororesin powder, and capable of suppressing foaming when the molded product is formed by using the fluororesin powder, and a molded product containing a fluororesin, excellent in abrasion resistance and having foaming suppressed.

### Solution to Problem

The present invention has the following embodiments.

<1> A method for producing a laminate comprising a substrate and a coating film formed on a surface of the substrate, which comprises applying the following powder composition to the surface of the substrate to form the coating film:

powder composition:

a powder composition comprising a fluororesin powder formed of a resin material containing the following fluororesin as the main component and having D50 of from 0.01 to 100 μm, and

a non-fluororesin powder formed of a resin material containing the following non-fluororesin as the main component and having D50 of from 0.01 to 100 μm,

wherein the proportion of the volume of the fluororesin powder to the total of the volume of the fluororesin powder and the volume of the non-fluororesin powder is from 99 to 1 vol %, and

the total of the volume of the fluororesin powder and the volume of the non-fluororesin powder to the volume of the powder composition is at least 80 vol %;

fluororesin:

a melt-moldable fluororesin having at least one type of functional group selected from the group consisting of a carbonyl group-containing group, a hydroxy group, an epoxy group, an amide group, an amino group and an isocyanate group;

non-fluororesin:

a resin selected from the group consisting of a polyarylketone, a thermoplastic polyimide, a polyamideimide, a polyetherimide, a polyarylene sulfide, a polyarylate, a polysulfone, a polyethersulfone, a liquid crystal polymer, and a cured product of a curable resin.

<2> The method for producing a laminate according to <1>, wherein D50 of the fluororesin powder is from 10 to 80 μm, and D50 of the non-fluororesin powder is from 1 to 80 μm.

<3> The method for producing a laminate according to <1> or <2>, wherein the substrate is made of a metal.

<4> The method for producing a laminate according to any one of <1> to <3>, wherein the powder composition is applied to the surface of the substrate by thermal spraying method or powder coating method.

<5> The method for producing a laminate according to any one of <1> to <4>, wherein the proportion of the volume of the fluororesin powder to the total of the volume of the fluororesin powder and the volume of the non-fluororesin powder is from 99 to 51 vol %, and the melting point of the fluororesin is from 260 to 320° C.

<6> A laminate comprising a substrate and a coating film formed on a surface of the substrate,

wherein the coating film contains the following fluororesin and the following non-fluororesin,

the proportion of the volume of the fluororesin to the total of the volume of the fluororesin and the non-fluororesin is from 99 to 1 vol %, and

the total of the volume of the fluororesin and the volume of the non-fluororesin to the volume of the coating film is at least 80 vol %,

fluororesin:

a melt-moldable fluororesin having at least one type of functional group selected from the group consisting of a carbonyl group-containing group, a hydroxy group, an epoxy group, an amide group, an amino group and an isocyanate group;

non-fluororesin:

a resin selected from the group consisting of a polyarylketone, a thermoplastic polyimide, a polyamideimide, a polyetherimide, a polyarylene sulfide, a polyarylate, a polysulfone, a polyethersulfone, a liquid crystal polymer, and a cured product of a curable resin.

<7> The laminate according to <6>, wherein the substrate is made of a metal.

<8> The laminate according to <6> or <7>, wherein the proportion of the volume of the fluororesin to the total of the volume of the fluororesin and the volume of the non-fluororesin is from 99 to 51 vol %, and the melting point of the fluororesin is from 260 to 320° C.

<9> The laminate according to <6> or <7>, wherein the proportion of one of the volume of the fluororesin and the volume of the non-fluororesin to the total of the volumes of the resins is from 99 to 60 vol %; in the resin with a higher volume proportion, the other resin is dispersed as particles; and the average dispersed particle size of said other resin is from 10 to 100 μm.

<10> A method for producing a molded product, which comprises compression-molding the following powder composition:

powder composition:

a powder composition comprising a fluororesin powder formed of a resin material containing the following fluororesin as the main component and having D50 of from 0.01 to 100 μm, and

a non-fluororesin powder formed of a resin material containing the following non-fluororesin as the main component and having D50 of from 0.01 to 100 μm,

wherein the proportion of the volume of the fluororesin powder to the total of the volume of the fluororesin powder and the volume of the non-fluororesin powder is from 99 to 1 vol %, and

the total of the volume of the fluororesin powder and the volume of the non-fluororesin powder to the volume of the powder composition is at least 80 vol %;

fluororesin:

a melt-moldable fluororesin having at least one type of functional group selected from the group consisting of a carbonyl group-containing group, a hydroxy group, an epoxy group, an amide group, an amino group and an isocyanate group;

non-fluororesin:

a resin selected from the group consisting of a polyarylketone, a thermoplastic polyimide, a polyamideimide, a polyetherimide, a polyarylene sulfide, a polyarylate, a polysulfone, a polyethersulfone, a liquid crystal polymer, and a cured product of a curable resin.

<11> The method for producing a molded product according to <10>, wherein D50 of the fluororesin powder is from 10 to 80 μm, and D50 of the non-fluororesin powder is from 1 to 80 μm.

<12> The method for producing a molded product according to <10> or <11>, wherein the proportion of the volume of the fluororesin powder to the total of the volume of the fluororesin powder and the volume of the non-fluororesin powder is from 99 to 51 vol %, and the melting point of the fluororesin is from 260 to 320° C.

<13> A molded product containing the following fluororesin and the following non-fluororesin,

wherein the proportion of the volume of the fluororesin to the total of the volume of the fluororesin and the volume of the non-fluororesin is from 99 to 1 vol %, and

the total of the volume of the fluororesin and the volume of the non-fluororesin to the volume of the molded product is at least 80 vol %;

fluororesin:

a melt-moldable fluororesin having at least one type of functional group selected from the group consisting of a carbonyl group-containing group, a hydroxy group, an epoxy group, an amide group, an amino group and an isocyanate group;

non-fluororesin:

a resin selected from the group consisting of a polyarylketone, a thermoplastic polyimide, a polyamideimide, a polyetherimide, a polyarylene sulfide, a polyarylate, a polysulfone, a polyethersulfone, a liquid crystal polymer, and a cured product of a curable resin.

<14> The molded product according to <13>, wherein the proportion of the volume of the fluororesin to the total of the volume of the fluororesin and the volume of the non-fluororesin is from 99 to 51 vol %, and the melting point of the fluororesin is from 260 to 320° C.

<15> The molded product according to <13>, wherein the proportion of one of the volume of the fluororesin and the volume of the non-fluororesin to the total of the volumes of the resins is from 99 to 60 vol %; in the resin with a higher volume proportion, the other resin is dispersed as particles; and the average dispersed particle size of said other resin is from 10 to 100 μm.

### Advantageous Effects of Invention

According to the method for producing a laminate of the present invention, it is possible to form a coating film excellent in abrasion resistance by using a fluororesin powder, and to suppress foaming when the coating film is formed by using a fluororesin powder.

The laminate of the present invention has a coating film containing a fluororesin, excellent in abrasion resistance and having foaming suppressed.

According to the method for producing a molded product of the present invention, it is possible to form a molded product excellent in abrasion resistance by using a fluororesin powder, and to suppress foaming when the molded product is formed by using the fluororesin powder.

The molded product of the present invention is a molded product containing a fluororesin, excellent in abrasion resistance and having foaming suppressed.

### BRIEF DESCRIPTION OF DRAWINGS

FIG. 1 is a cross-sectional view illustrating an example of a laminate of the present invention.

### DESCRIPTION OF EMBODIMENTS

In this specification, meanings and definitions of terms are as follows.

“Melt-moldable” means having melt flowability.

“Having melt flowability” means that a temperature at which MFR is from 0.1 to 1,000 g/10 min is present at a temperature higher by at least 20° C. than the melting point of the resin under a load of 49N.

“MFR” is a melt mass flow rate as specified by JIS K7210-1: 2014 (corresponding international standard ISO 1133-1: 2011).

“Melting point” means a temperature corresponding to a maximum value of the melting peak measured by differential scanning calorimetry (DSC) method.

“D50” of a resin powder is a volume-based cumulative 50% diameter obtained by laser diffraction/scattering method. That is, it is a particle size at which the cumulative volume is 50% on a cumulative curve obtained by measuring the particle size distribution by laser diffraction/scattering method and taking the total volume of the group of particles being 100%.

The “average dispersed particle size” of resin particles dispersed in the coating film of the laminate and the molded product is obtained as follows.

A cross section or a surface of the coating film of the laminate or the molded product is observed by a microscope such as a scanning electron microscope (FE-SEM), and images of n (n=20 or more) of dispersed particles present in the microscopic image are photographed and binarized by means of a software to obtain the area of the dispersed particles, the diameter assuming the area of the dispersed particle to be a circle is taken as the dispersed particle size, and the average of the dispersed particle sizes is taken as the average dispersed particle size.

An “acid anhydride residue” means a group represented by —C(═O)−O—C(═O)—.

A “(meth)acrylate” generally means an acrylate and a methacrylate, a “(meth)acryloyloxy” group generally means an acryloyloxy group and a methacryloyloxy group, and a “(meth)acrylamide” generally means an acrylamide and a methacrylamide.

A “unit based on a monomer” generally means an atomic group directly formed by polymerization of one monomer molecule, and an atomic group obtained by chemical conversion of a part of the atomic group. In this specification, a unit based on a monomer may sometimes be referred to simply as a monomer units.

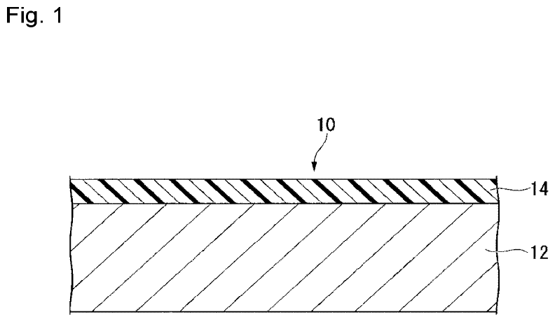

The dimensional ratio in FIG. 1 is different from an actual one for convenience of explanation.

In the present invention, the “melt-moldable fluororesin having at least one type of functional group selected from the group consisting of a carbonyl group-containing group, a hydroxy group, an epoxy group, an amide group, an amino group and an isocyanate group” will sometimes be referred to as “fluororesin A”. Further, the functional group which the fluororesin A has will be referred to as “adhesive functional group”.

Further, in the present invention, the “resin selected from the group consisting of a polyarylketone, a thermoplastic polyimide, a polyamideimide, a polyetherimide, a polyarylene sulfide, a polyarylate, a polysulfone, a polyethersulfone, a liquid crystal polymer and a cured product of a curable resin” will sometimes be referred to as “resin B”.

In the present invention, a “powder of the fluororesin A formed of a resin material containing the fluororesin A as the main component and having D50 of from 0.01 to 100 μm” will sometimes be referred to as “fluororesin powder X”. The “resin material containing the fluororesin A as the main component” in the fluororesin powder X will be referred to as “resin material I”.

Further, in the present invention, a “powder of the resin B formed of a resin material containing the resin B as the main component and having D50 of from 0.01 to 100 μm” will sometimes be referred to as “resin powder Y”. The “resin material containing the resin B as the main component” in the resin powder Y will be referred to as “resin material II”.

### <Laminate>

FIG. 1 is a cross-sectional view illustrating an example of the laminate of the present invention.

A laminate 10 comprises a substrate 12 and a coating film 14 formed on the surface of the substrate 12.

The substrate is preferably one made of a metal, in that the coating film is easily formed by the after-described thermal spraying method or powder coating method. The metal may, for example, be aluminum, iron, zinc, tin, titanium, lead, alloy steel, stainless steel, copper, magnesium or brass. The material of the substrate may properly be selected depending upon e.g. application of the laminate. The substrate may contain two or more of the exemplified metals. The shape, the size, etc. of the substrate are not particularly limited.

The coating film contains the fluororesin A and the resin B. The coating film may contain, within a range not to impair the effects of the present invention, as the case requires, a component other than the fluororesin A and the resin B. Further, the coating film may contain two or more types of the fluororesins A, and may contain two or more types of the resins B.

The proportion of the volume of the fluororesin A in the coating film is from 99 to 1 vol % to the total of the volume of the fluororesin A and the volume of the resin B. When the proportion of the volume of the fluororesin A is at most 99 vol %, the resulting coating film will be excellent in abrasion resistance. Further, foaming of the coating film can be suppressed. When the proportion of the volume of the fluororesin A is at least 1 vol %, the coating film will be excellent in sliding properties.

The proportion of the volume of the fluororesin A in the coating film to the total of the volume of the fluororesin A and the volume of the resin B is preferably from 99 to 51 vol %, more preferably from 99 to 60 vol %, further preferably from 99 to 70 vol %. When the proportion of the volume of the fluororesin A is at most the upper limit value of the above range, the coating film will be excellent in abrasion resistance. When the proportion of the volume of the fluororesin A is at least the lower limit value of the above range, properties of the coating film due to the fluororesin A, such as low friction property and chemical resistance, will be sufficiently obtained.

It is considered that when the coating film has low friction property by the fluororesin A, its abrasion resistance may sometimes improve. Further, when the proportion of the volume of the resin B increases within the above range, adhesion between the substrate and the coating film tends to improve.

Further, in a case where properties of the coating film due to the resin B, such as abrasion resistance, are to be sufficiently obtained, the proportion of the volume of the fluororesin A to the total of the volume of the fluororesin A and the volume of the resin B is preferably from 1 to 51 vol %, more preferably from 1 to 40 vol %, further preferably from 1 to 30 vol %.

The total of the volume of the fluororesin A and the volume of the resin B to the volume of the coating film is at least 80 vol %, preferably at least 85 vol %, further preferably at least 90 vol %. When the total of the volume of the fluororesin A and the volume of the resin B is at least the lower limit value of the above range, the coating film will be excellent in abrasion resistance, while properties of the coating film due to the fluororesin A are sufficiently obtained.

In a case where the proportion of the volume of the fluororesin in the coating film to the total of the volume of the fluororesin A and the volume of the resin B is from 99 to 60 vol %, the average dispersed particle size of the resin B dispersed in the coating film is from 10 to 100 μm, preferably from 15 to 100 μm, more preferably from 20 to 100 μm. In such a case, the proportion of the volume of the fluororesin is more preferably from 99 to 70 vol %. When the average dispersed particle size of the resin B is at least the lower limit value of the above range, the coating property for the coating film will be excellent. When the average dispersed particle size of the resin B is at most the upper limit value of the above range, the coating film will be excellent in the outer appearance.

Further, When the proportion of the volume of the resin B in the coating film to the total of the volume of the fluororesin A and the volume of the resin B is from 99 to 60 vol %, the average dispersed particle size of the fluororesin A dispersed in the coating film is from 10 to 100 μm, preferably from 15 to 100 μm, more preferably from 20 to 100 μm. In such a case, the proportion of the volume of the resin B is more preferably from 99 to 70 vol %. When the average dispersed particle size of the fluororesin A is at least the lower limit value of the above range, the coating film will be excellent in outer appearance. When the average dispersed particle size of the fluororesin A is at most the upper limit value of the above range, the coating property for the coating film will excellent.

The thickness of the coating film is preferably from 1 to 3,000 μm, more preferably from 5 to 2,500 μm, further preferably from 10 to 2,000 μm. The thickness of the coating film may suitably be set depending upon e.g. properties required for the laminate.

For example, in a case where D50 of the fluororesin powder X or the resin powder Y is from 0.01 to 10 μm, the thickness of the coating film is preferably from 10 to 50 μm.

Further, in a case where D50 of the fluororesin powder X is from 10 to 80 μm, and D50 of the resin powder Y is from 1 to 80 μm, the thickness of the coating film is preferably from 20 to 2,000 μm, more preferably from 50 to 1,000 μm, further preferably from 100 to 500 μm.

Further, in a case where in production of the laminate, application of the powder composition and firing are repeatedly conducted, the total thickness of the obtained respective coating films is to be within the above range.

The laminate of the present invention may have, within a range not to impair the effects of the present invention, as the case requires, other layer.

Other layer may, for example, be a resin layer containing either one of the fluororesin A and the resin B, or a resin layer containing neither fluororesin A nor resin B.

### (Fluororesin A)

The fluororesin A has an adhesive functional group. The adhesive functional group is preferably present as at least one of the terminal group of the main chain of the fluororesin A and the pendant group of the main chain, in view of excellent adhesion between the substrate and the coating film. The fluororesin A may have two or more types of adhesive functional groups.

The fluororesin A preferably has at least a carbonyl group-containing group as the adhesive functional group, in view of more excellent adhesion between the substrate and the coating film.

The carbonyl group-containing group may, for example, be a group having a carbonyl group between carbon atoms of a hydrocarbon group, a carbonate group, a carboxy group, a haloformyl group, an alkoxycarbonyl group, an acid anhydride residue, a polyfluoroalkoxycarbonyl group or a fatty acid residue. The carbonyl group-containing group is, in view of more excellent adhesion between the substrate and the coating film, a group having a carbonyl group between carbon atoms of a hydrocarbon group, a carbonate group, a carboxy group, a haloformyl group, an alkoxycarbonyl group or an acid anhydride residue, more preferably a carboxy group or an acid anhydride residue.

In the group having a carbonyl group between carbon atoms of a hydrocarbon, the hydrocarbon group may, for example, be a C₂₋₈ alkylene group. The number of carbon atoms in the alkylene group is a number of carbon atoms not including carbon atoms constituting the carbonyl group. The alkylene group may be linear or branched.

The haloformyl group is represented by —C(═O)—X (wherein X is a halogen atom). The halogen atom in the haloformyl group may, for example, be a fluorine atom or a chlorine atom, and is preferably a fluorine atom.

The alkoxy group in the alkoxycarbonyl group may be linear or branched, and is preferably a C₁₋₈ alkoxy group, more preferably a methoxy group or an ethoxy group.

The melting point of the fluororesin A is preferably from 260 to 320° C., more preferably from 280 to 320° C., further preferably from 295 to 315° C., particularly preferably from 295 to 310° C. When the melting point of the fluororesin A is at least the lower limit value of the above range, the coating film is excellent in heat resistance. When the melting point of the fluororesin A is at most the upper limit value of the above range, the fluororesin A will be excellent in melt-moldability.

The melting point of the fluororesin A may be adjusted e.g. by the type and the proportion of the units constituting the fluororesin A, and the molecular weight of the fluororesin A. For example, the melting point tends to increase as the proportion of the TFE units increases.

MFR of the fluororesin A at a temperature higher by at least 20° C. than the melting point of the fluororesin A is preferably from 0.1 to 1,000 g/10 min, more preferably from 0.5 to 100 g/10 min, further preferably from 1 to 30 g/10 min, particularly preferably from 5 to 20 g/10 min. The measurement temperature is preferably a temperature higher by at least 50° C. than the melting point, more preferably a temperature higher by from 50 to 80° C. For example, fluorinated copolymer (A1-1) used in Examples has a melting point of 300° C. at a measurement temperature of 372° C., which is higher by 72° C. than the melting point.

When MFR is at least the lower limit value of the above range, the fluororesin A will be excellent in melt-moldability, and the coating film will be excellent in outer appearance. When MFR is at most the upper limit value of the above range, the coating film will be excellent in mechanical strength.

MFR is an index of the molecular weight of the fluororesin A, and a high MFR means a low molecular weight, and a low MFR means a high molecular weight.

MFR of the fluororesin A may be adjusted by conditions for production of the fluororesin A. For example, MFR tends to be high when the polymerization time is shortened at the time of polymerization of the monomer.

The fluororesin A is, in view of more excellent adhesion between the substrate and the coating film, preferably a fluorinated copolymer (hereinafter referred to as “copolymer A1”) having units having an adhesive functional group (hereinafter sometimes referred to as “adhesive functional group-containing units”) and units based on tetrafluoroethylene (hereinafter sometimes referred to as “TFE”).

The copolymer A1 may have units other than the adhesive functional group-containing units and TFE units.

The adhesive functional group-containing units are preferably units based on an adhesive functional group-containing monomer.

The number of the adhesive functional group which the adhesive functional group-containing monomer has may be one or two or more. In a case where the adhesive functional group-containing monomer has two or more adhesive functional groups, the two or more adhesive functional groups may be the same or different.

The adhesive functional group-containing monomer is preferably a compound having one adhesive functional group and having one polymerizable carbon-carbon double bond.

The adhesive functional group-containing monomer may, for example, be a monomer having a carbonyl group-containing group, a hydroxy group-containing monomer, an epoxy group-containing monomer or an isocyanate group-containing monomer. The adhesive functional group-containing monomer is preferably a monomer having a carbonyl group-containing group in view of more excellent adhesion between the substrate and the coating film.

The monomer having a carbonyl group-containing group may, for example, be an acid anhydride residue-containing cyclic monomer, a carboxy group-containing monomer, a vinyl ester, a (meth)acrylate or CF₂═CFOR^{f1}CO₂X¹ (wherein R^{f1} is a C₁₋₁₀ perfluoroalkylene group or a group having an etheric oxygen atom between carbon atoms of a C₂₋₁₀ perfluoroalkylene group, and X¹ is a hydrogen atom or a C₁₋₃ alkyl group).

The acid anhydride residue-containing cyclic monomer may, for example, be an unsaturated dicarboxylic acid anhydride. The unsaturated dicarboxylic acid anhydride may, for example, be itaconic anhydride (hereinafter sometimes referred to as “IAH”), citraconic anhydride (hereinafter sometimes referred to as “CAH”), 5-norbornene-2,3-dicarboxylic acid anhydride (another name: himic anhydride, hereinafter sometimes referred to as “NAH”) or maleic anhydride.

The carboxy group-containing monomer may, for example, be an unsaturated dicarboxylic acid (such as itaconic acid, citraconic acid, 5-norbornene-2,3-dicarboxylic acid or maleic acid) or an unsaturated monocarboxylic acid (such as acrylic acid or methacrylic acid).

The vinyl ester may, for example, be vinyl acetate, vinyl chloroacetate, vinyl butanoate, vinyl pivalate, vinyl benzoate or vinyl crotonate.

The (meth)acrylate may, for example, be a (polyfluoroalkyl) acrylate or a (polyfluoroalkyl) methacrylate.

The monomer having a carbonyl group-containing group is, in view of more excellent adhesion between the substrate and the coating film, preferably an acid anhydride residue-containing cyclic monomer, more preferably IAH, CAH or NAH. By using at least one member selected from the group consisting of IAH, CAH and NAH, copolymer A1 having an acid anhydride residue can easily be produced without using a special polymerization method (see JP-A-H11-193312) which is required when maleic anhydride is used. The monomer having a carbonyl group-containing group is particularly preferably NAH in view of excellent adhesion between the copolymer A1 and the resin B in the coating film.

The hydroxy group-containing monomer may, for example, be a hydroxy group-containing vinyl ester, a hydroxy group-containing vinyl ether, a hydroxy group-containing allyl ether, a hydroxy group-containing (meth)acrylate, hydroxyethyl crotonate or allyl alcohol.

The epoxy group-containing monomer may, for example, be an unsaturated glycidyl ether (such as allyl glycidyl ether, 2-methylallyl glycidyl ether or vinyl glycidyl ether) or an unsaturated glycidyl ester (such as glycidyl acrylate or glycidyl methacrylate).

The amide group-containing monomer may, for example, be (meth)acrylamide.

The amino group-containing monomer may, for example, be dimethylaminoethyl (meth)acrylate.

The isocyanate group-containing monomer may, for example, be 2-(meth)acryloyloxyethyl isocyanate, 2-(2-(meth)acryloyloxyethoxy)ethyl isocyanate or 1,1-bis((meth)acryloyloxymethyl)ethyl isocyanate.

The adhesive functional group-containing monomer may be used in combination of two or more.

The units other than the adhesive functional group-containing units and the TFE units may, for example, be units based on a perfluoro(alkyl vinyl ether) (hereinafter sometimes referred to as “PAVE”), units based on hexafluoropropylene (hereinafter sometimes referred to as “HFP”), or units based on a monomer other than the adhesive functional group-containing monomer, TFE, PAVE and HFP.

PAVE may be CF₂═CFOR^{f2} (wherein R^{f2} is a C₁₋₁₀ perfluoroalkyl group or a group having an etheric oxygen atom between carbon atoms of a C₂₋₁₀ perfluoroalkyl group).

The perfluoroalkyl group as R^{f2} may be linear or branched. R^{f2} preferably has from 1 to 3 carbon atoms.

CF₂═CFOR^{f2} may, for example, be CF₂═CFOCF₃, CF₂═CFOCF₂CF₃, CF₂═CFOCF₂CF₂CF₃ (hereinafter sometimes referred to as “PPVE”), CF₂═CFOCF₂CF₂CF₂CF₃ or CF₂═CFO(CF₂)₈F, and is preferably PPVE.

PAVE may be used in combination of two or more.

Other monomer may, for example, be other fluorinated monomer (excluding the adhesive functional group-containing monomer, TFE, PAVE and HFP), or other non-fluorinated monomer (excluding the adhesive functional group-containing monomer).

Other fluorinated monomer may, for example, be a fluoroolefin excluding TFE and HFP (such as vinyl fluoride, vinylidene fluoride (hereinafter sometimes referred to as “VdF”), trifluoroethylene or chlorotrifluoroethylene (hereinafter sometimes referred to as “CTFE”)), CF₂═CFOR^{f3}SO₂X³ (wherein R^{f3} is a C₁₋₁₀ perfluoroalkylene group or a group having an etheric oxygen atom between carbon atoms of a C₂₋₁₀ perfluoroalkylene group, X³ is a halogen atom or a hydroxy group), CF₂═CF(CF₂)ₚOCF═CF₂ (wherein p is 1 or 2), CH₂═CX⁴(CF₂)_{q}X⁵ (wherein X⁴ is a hydrogen atom or a fluorine atom, q is an integer of from 2 to 10, and X⁵ is a hydrogen atom or a fluorine atom), or perfluoro(2-methylene-4-methyl-1,3-dioxolane). Other fluorinated monomer may be used in combination of two or more.

Other fluorinated monomer is preferably VdF, CTFE or CH₂═CX⁴(CF₂)_{q}X⁵ .

CH₂═CX⁴(CF₂)_{q}X⁵ may, for example, be CH₂═CH(CF₂)₂F, CH₂═CH(CF₂)₃F, CH₂═CH(CF₂)₄F, CH₂═CF(CF₂)₃H or CH₂═CF(CF₂)₄H, and is preferably CH₂═CH(CF₂)₄F or CH₂═CH(CF₂)₂F.

Other non-fluorinated monomer may, for example, be an olefin having at most 3 carbon atoms (such as ethylene or propylene), and is preferably ethylene or propylene, particularly preferably ethylene. Other non-fluorinated monomer may be used alone or in combination of two or more.

As other monomer, other fluorinated monomer and other non-fluorinated monomer may be used in combination.

The copolymer A1 may have an adhesive functional group as the main chain terminal group. The adhesive functional group as the main chain terminal group is preferably an alkoxycarbonyl group, a carbonate group, a carboxy group, a fluoroformyl group, an acid anhydride residue or a hydroxy group. The adhesive functional group as the main chain terminal group may be introduced by properly selecting a radical polymerization initiator, a chain transfer agent or the like used at the time of production of the copolymer A1.

The copolymer A1 is, in view of excellent heat resistance of the coating film, preferably the following copolymer A11 or the following copolymer A12, particularly preferably the copolymer A11.

Copolymer A11: fluorinated copolymer having adhesive functional group-containing units, TFE units and PAVE units.

Copolymer A12: fluorinated copolymer having adhesive functional group-containing units, TFE units and HFP units.

The copolymer A11 may further have at least either one of the HFP units and other monomer units as the case requires. That is, the copolymer A11 may be a copolymer comprising adhesive functional group-containing units, TFE units and PAVE units, may be a copolymer comprising adhesive functional group-containing units, TFE units, PAVE units and HFP units, may be a copolymer comprising adhesive functional group-containing units, TFE units, PAVE units and other monomer units, or may be a copolymer comprising adhesive functional group-containing units, TFE units, PAVE units, HFP units and other monomer units.

The copolymer A11 is, in view of more excellent adhesion between the substrate and the coating film, preferably a copolymer having units based on a monomer having a carbonyl group-containing group, TFE units and PAVE units, particularly preferably a copolymer having units based on an acid anhydride residue-containing cyclic monomer, TFE units and PAVE units. As preferred specific examples of the copolymer A11, the following may be mentioned.

A copolymer having TFE units, PPVE units and NAH units, a copolymer having TFE units, PPVE units and IAH units, and a copolymer having TFE units, PPVE units and CAH units.

The proportion of the adhesive functional group-containing units in the copolymer A11 to all units constituting the copolymer A11 is preferably from 0.01 to 3 mol %, more preferably from 0.03 to 2 mol %, further preferably from 0.05 to 1 mol %. When the proportion of the adhesive functional group-containing units is at least the lower limit value of the above range, adhesion between the copolymer A11 and the resin B in the coating film will be excellent, and the adhesion between the substrate and the coating film will be more excellent. When the proportion of the adhesive functional group-containing units is at most the upper limit value of the above range, the coating film will be excellent in heat resistance, color tone, etc.

The proportion of the TFE units in the copolymer A11 to all units constituting the copolymer A11 is preferably from 90 to 99.89 mol %, more preferably from 95 to 99.47 mol %, further preferably from 96 to 98.95 mol %. When the proportion of the TFE units is at least the lower limit value of the above range, the copolymer A11 will be excellent in electrical properties (such as low dielectric constant), heat resistance, chemical resistance, etc. When the proportion of the TFE units is at most the upper limit value of the above range, the copolymer A11 will be excellent in melt-moldability, etc.

The proportion of the PAVE units in the copolymer A11 to all units constituting the copolymer A11 is preferably from 0.1 to 9.99 mol %, more preferably from 0.5 to 9.97 mol %, further preferably from 1 to 9.95 mol %. When the proportion of the PAVE units is within the above range, the copolymer A11 will be excellent in melt-moldability.

The total of the adhesive functional group-containing units, the TFE units and the PAVE units in the copolymer A11 is preferably at least 90 mol %, more preferably at least 95 mol %, further preferably at least 98 mol %. The upper limit value of the total of the adhesive functional group-containing units, the TFE units and the PAVE units is 100 mol %.

The copolymer A12 may further have at least either one of the PAVE units and other monomer units as the case requires. That is, the copolymer A12 may be a copolymer comprising adhesive functional group-containing units, TFE units and HFP units, may be a copolymer comprising adhesive functional group-containing units, TFE units, HFP units and PAVE units, may be a copolymer comprising adhesive functional group-containing units, TFE units, HFP units and other monomer units, or may be a copolymer comprising adhesive functional group-containing units, TFE units, HFP units, PAVE units and other monomer units.

The copolymer A12 is, in view of more excellent adhesion between the substrate and the coating film, preferably a copolymer having units based on a monomer having a carbonyl group-containing group, TFE units and HFP units, particularly preferably a copolymer having units based on an acid anhydride residue-containing cyclic monomer, TFE units and HFP units. As preferred specific examples of the copolymer A12, the following may be mentioned.

A copolymer having TFE units, HFP units and NAH units, a copolymer having TFE units, HFP units and IAH units, and a copolymer having TFE units, HFP units and CAH units.

The proportion of the adhesive functional group-containing units in the copolymer A12 to all units constituting the copolymer A12 is preferably from 0.01 to 3 mol %, more preferably from 0.02 to 2 mol %, further preferably from 0.05 to 1.5 mol %. When the proportion of the adhesive functional group-containing units is at least the lower limit value of the above range, adhesion between the copolymer A12 and the resin B in the coating film will be excellent, and the adhesion between the substrate and the coating film will be more excellent. When the proportion of the adhesive functional group-containing units is at most the upper limit value of the above range, the coating film will be excellent in heat resistance, color tone, etc.

The proportion of the TFE units in the copolymer A12 to all units constituting the copolymer A12 is preferably from 90 to 99.89 mol %, more preferably from 91 to 98 mol %, further preferably from 92 to 96 mol %. When the proportion of the TFE units is at least the lower limit value of the above range, the copolymer A12 will be excellent in electrical properties (such as low dielectric constant), heat resistance, chemical resistance, etc. When the proportion of the TFE units is at most the upper limit value of the above range, the copolymer A12 will be excellent in melt-moldability, etc.

The proportion of the HFP units in the copolymer A12 to all units constituting the copolymer A12 is preferably from 0.1 to 9.99 mol %, more preferably from 1 to 9 mol %, further preferably from 2 to 8 mol %. When the proportion of the HFP units is within the above range, the copolymer A12 will be excellent in melt-moldability.

The total of the adhesive functional group-containing units, the TFE units and the HFP units in the copolymer A12 is preferably at least 90 mol %, more preferably at least 95 mol %, further preferably at least 98 mol %. The upper limit value of the total of the adhesive functional group-containing units, the TFE units and the HFP units is 100 mol %.

The proportion of the respective units in the copolymer A1 may be obtained e.g. by nuclear magnetic resonance (NMR) analysis such as melt NMR analysis, fluorine content analysis or infrared absorption spectrum analysis. For example, as disclosed in JP-A-2007-314720, by means of e.g. infrared absorption spectrum analysis, the proportion (mol %) of the adhesive functional group-containing units in all units constituting the copolymer A1 may be obtained.

As a method for producing the copolymer A1, for example, the following methods may be mentioned.
A method of polymerizing an adhesive functional group-containing monomer and TFE and as a case requires, PAVE, FEP or other monomer.
A method of heating a copolymer having units having a functional group convertible to an adhesive functional group when decomposed by heat, and TFE units, to thermally decompose the functional group convertible to an adhesive functional group thereby to form an adhesive functional group (such as a carboxy group).
A method of subjecting a monomer having an adhesive functional group to graft polymerization to a copolymer having TFE units.

As a method for producing the copolymer A1, a method of polymerizing the adhesive functional group-containing monomer and TFE and as the case require, PAVE, FEP and other monomer.

As the polymerization method, preferred is polymerization method using a radical polymerization initiator.

At the time of polymerization, a chain transfer agent may be used to control the molecular weight and the melt viscosity of the copolymer A1.

A compound having an adhesive functional group may be used as at least one of the radical polymerization initiator and the chain transfer agent. By using the compound having an adhesive functional group, the adhesive functional group may be introduced to the main chain terminal of the copolymer A1.

The polymerization method may be bulk polymerization, solution polymerization using an organic solvent, suspension polymerization using an aqueous medium and as the case requires, a proper organic solvent, or emulsion polymerization using an aqueous medium and an emulsifier, and is preferably solution polymerization.

The organic solvent used in solution polymerization may, for example, be a perfluorocarbon, a hydrofluorocarbon, a hydrochlorofluorocarbon or a hydrofluoroether.

The polymerization temperature is preferably from 0 to 100° C., more preferably from 20 to 90° C.

The polymerization pressure is preferably from 0.1 to 10 MPa, more preferably from 0.5 to 3 MPa.

The polymerization time is preferably from 1 to 30 hours.

In a case where an acid anhydride residue-containing cyclic monomer is used as the adhesive functional group-containing monomer, the proportion of the acid anhydride residue-containing cyclic monomer during polymerization, to all the monomers, is preferably from 0.01 to 5 mol %, more preferably from 0.1 to 3 mol %, further preferably from 0.1 to 2 mol %. When the proportion of the acid anhydride residue-containing cyclic monomer is within the above range, the polymerization rate will be appropriate. If the proportion of the acid anhydride residue-containing cyclic monomer is too high, the polymerization rate tends to be low. It is preferred to supply the acid anhydride residue-containing cyclic monomer in an amount corresponding to the amount consumed by the polymerization continuously or intermittently to a polymerization vessel thereby to maintain the proportion of the acid anhydride residue-containing cyclic monomer to be within the above range.

### (Resin B)

The resin B is a resin selected from the group consisting of a polyarylketone, a thermoplastic polyimide, a polyamideimide, a polyetherimide, a polyarylene sulfide, a polyarylate, a polysulfone, a polyethersulfone, a liquid crystal polymer and a cured product of a curable resin.

Such a resin (other than the cured product of a curable resin) is a resin incompatible with the fluororesin A, and even when a mixture of a powder of the fluororesin A and a powder of the resin B is heated to a temperature of the melting point of the resin or higher and melted, the resins are separated when cooled and no uniform mixed resin will be obtained. Particularly if the difference of the blend ratios of both the resin powders is significant, the resin with the lower blend ratio becomes particles, whereby a mixed resin having a sea/island structure is obtained. The proportion of the volume of the resin constituting the sea of the sea/island structure is preferably from 99 to 60 vol %, more preferably from 99 to 70 vol % to the total of the volume of the fluororesin A and the volume of the resin B.

In a case where the resin B is the cured product of a curable resin, the resin B coexists with the fluororesin A in the form of powder particles as they are.

The polyarylketone is one having an aromatic ring, an ether bond and a ketone bond in its molecule. The polyarylketone may, for example, be a polyetherketone, a polyetheretherketone (hereinafter sometimes referred to as “PEEK”) or a polyetherketoneketone (hereinafter sometimes referred to as “PEKK”). The polyarylketone is preferably PEEK or PEKK in view of coating film forming property, adhesion to the substrate and availability. PEEK and PEKK may be properly selected depending upon the application and the purpose, and when PEEK is used, a coating film excellent in abrasion resistance will be obtained, and when PEKK is used, a coating film more excellent in surface smoothness will be obtained.

The thermoplastic polyimide is one having a proportion of imide groups decreased by introducing, when an aromatic tetracarboxylic dianhydride and an aromatic diamine are polycondensed, a thermally stable functional group other than the imide group and an aromatic atomic group.

The polyamideimide may, for example, be one obtained by polycondensing an aromatic dicarboxylic acid and an aromatic diisocyanate or one obtained by polycondensing an aromatic acid anhydride and an aromatic diisocyanate. The aromatic dicarboxylic acid may, for example, be isophthalic acid or terephthalic acid. The aromatic acid anhydride may, for example, be trimellitic anhydride. The aromatic diisocyanate may, for example, be 4,4′-diphenylmethane diisocyanate, 2,4-tolylene diisocyanate, 2,6-tolylene diisocyanate, o-tolylene diisocyanate or m-xylene diisocyanate.

The polyetherimide is one having an imide bond and an ether bond in its molecule. The polyetherimide may, for example, be one obtained by polycondensing 2,2-bis{4-(3,4-dicarboxyphenoxy)phenyl}propane dianhydride and m-phenylenediamine.

The polyarylene sulfide may be one having units represented by -A-S— (wherein A is an arylene group). The proportion of the -A-S— units in the polyarylene sulfide is preferably at least 70 mol %. The arylene group may, for example, be a p-phenylene group, a m-phenylene group, an o-phenylene group, an alkyl-substituted phenylene group, a phenyl-substituted phenylene group, a halogen-substituted phenylene group, an amino-substituted phenylene group, an amide-substituted phenylene group, a p,p′-diphenylenesulfone group, a p,p′-biphenylene group or a p,p′-biphenylene ether group. The polyarylene sulfide may be a crosslinked type or may be a linear type.

The polyarylate may, for example, be one obtained by polycondensing a dihydric phenol such as bisphenol A and an aromatic dicarboxylic acid such as terephthalic acid or isophthalic acid.

The polysulfone may, for example, be one obtained by polycondensing bisphenol A and 4,4′-dichlorodiphenylsulfone.

The polyethersulfone may, for example, be one obtained by polycondensing dihalogenodiphenylsulfone and bisphenol.

The liquid crystal polymer may, for example, be a liquid crystal polyester such as a paraoxybenzoic acid/polyethylene terephthalate copolymer, a hydroxynaphthoic acid/paraoxybenzoic acid copolymer or a biphenol/benzoic acid/paraoxybenzoic acid.

The curable resin is preferably a thermosetting resin. The thermosetting resin may, for example, be a thermosetting polyimide, an epoxy resin, an acrylic resin, a phenol resin, a melamine resin or a urea resin. The cured product of the thermosetting polyimide may be one obtained by heat-treating a varnish containing as the main component a polyimide precursor obtained by polycondensing an aromatic diamine and at least one of an aromatic tetracarboxylic acid and its anhydride.

In the present invention, one obtained by curing such a curable resin is used as the resin B. The curable resin before curing has low hardness, and does not contribute to the improvement of abrasion resistance, used as the resin B.

In a case where the resin B is other than the cured product of the curable resin, the melting point is preferably at least 200° C., more preferably from 210 to 400° C. When the melting point of the resin B is at least the above lower limit value, heat resistance of the coating film will improve. When it is at most the upper limit value, the resin B will be excellent in melt-moldability.

The specific gravity of the resin B is preferably at least 1.1, more preferably from 1.20 to 2.0, further preferably from 1.3 to 2.0. When the specific gravity of the resin B is at least the above lower limit value, the coating film will be excellent in abrasion resistance. When it is at most the upper limit value, the resin B tends to be uniformly mixed with the fluororesin A.

In a case where the resin B is dissolved in an organic solvent to form a resin solution, which is mixed with a powder of the fluororesin A, the powder of the fluororesin A will sediment and not be present on the coating film surface, and effects of the fluororesin such as low friction property and chemical resistance will hardly be obtained.

According to the production method of the present invention, the resin B is also formed into a powder, whereby the respective effects of the resin B and the fluororesin A will be obtained.

### (Other Component)

Other component which the coating film may contain may, for example, be an ultraviolet absorber, a pigment, a light stabilizer, a delustering agent, a surfactant, a leveling agent, a surface modifier, a degassing agent, a filler, a thermal stabilizer, a thickener, a dispersing agent, an antistatic agent, a lust-preventing agent, a silane coupling agent, an anti-fouling agent or a low contamination treatment agent.

As the ultraviolet absorber, either ultraviolet absorber of an organic ultraviolet absorber and an inorganic ultraviolet absorber may be used.

The pigment is preferably a luster pigment, an antirust pigment, a coloring pigment or an extender pigment.

The filler may, for example, be glass fibers, carbon fibers, glass fibers-ground particles, carbon fibers-ground particles, organic particles or inorganic particles.

### <Powder Composition>

The powder composition used for the method for producing a laminate of the present invention and the method for producing a molded product of the present invention, contains the fluororesin powder X and the resin powder Y.

The powder composition may contain, within a range not to impair the effects of the present invention, as the case requires, a powder other than the fluororesin powder X and the resin powder Y.

The powder composition may be prepared, for example, by mixing the fluororesin powder X and the resin powder Y and as the case requires, other powder, in a predetermined volume ratio.

The proportion of the volume of the fluororesin powder X in the powder composition, to the total of the volume of the fluororesin powder X and the volume of the resin powder Y, is from 99 to 1 vol %. When the proportion of the volume of the fluororesin powder X is at most 99 vol %, the coating film will be excellent in abrasion resistance. Further, foaming at the time of forming the coating film will be suppressed. When the proportion of the volume of the fluororesin powder X is at least 1 vol %, the coating film will be excellent in sliding properties.

The proportion of the volume of the fluororesin powder X in the powder composition to the total of the volume of the fluororesin powder X and the volume of the resin powder Y is preferably from 99 to 51 vol %, more preferably from 99 to 60 vol %, further preferably from 99 to 70 vol %. When the proportion of the volume of the fluororesin powder X is at most the upper limit value of the above range, the coating film will be excellent in abrasion resistance. When the proportion of the volume of the fluororesin powder X is at least the lower limit value of the above range, properties of the coating film due to the fluororesin A, such as low friction property and chemical resistance will be sufficiently obtained. Further, when the proportion of the volume of the resin powder Y increases within the above range, adhesion between the substrate and the coating film is likely to improve.

In a case where properties of the coating film due to the resin B, such as abrasion resistance, are to be sufficiently obtained, the proportion of the volume of the fluororesin powder X to the total of the volume of the fluororesin powder X and the volume of the resin powder Y is preferably from 1 to 51 vol %, more preferably from 1 to 40 vol %, further preferably from 1 to 30 vol %.

The total of the volume of the fluororesin powder X and the volume of the resin powder Y to the volume of the powder composition is at least 80 vol %, more preferably at least 85 vol %, further preferably at least 90 vol %. When the total of the volume of the fluororesin powder X and the volume of the resin powder Y is at least the lower limit value of the above range, the coating film will be excellent in abrasion resistance while properties of the coating film due to the fluororesin A will be sufficiently obtained.

### (Fluororesin Powder X)

The fluororesin powder X comprises resin material I containing the fluororesin A as the main component.

The resin material I containing the fluororesin A as the main component means that the proportion of the fluororesin A in the resin material I is at least 80 mass %. The proportion of the fluororesin A to the resin material I is preferably at least 85 mass %, more preferably at least 90 mass %, particularly preferably 100 mass %. When the fluororesin A is contained as the main component, properties of the coating film due to the fluororesin A will be sufficiently obtained.

The fluororesin A contained in the resin material I may be used in combination of two or more.

The resin material I preferably contains no resin B. A resin material containing the fluororesin A and the resin B is likely to be fibrillated at the time of grinding, whereby a resin powder is hardly produced.

The resin material I may further contain, within a range not to impair the effects of the present invention, as the case requires, a component other than the fluororesin A (excluding the resin B).

The fluororesin powder X may be a powder containing two or more types of resin particles. For example, it may be a fluororesin powder containing resin particles comprising a first resin material I and resin particles comprising a second resin material I different from the first resin material I. The first resin material I and the second resin material I are materials differing in the composition, for example, differing in the type of the fluororesin A, differing in the content of the fluororesin A, or differing in the component other than the fluororesin A.

Further, the fluororesin powder X may contain two or more types of fluororesin powders X. For example, it may be a mixture of separately produced fluororesin powders X differing in D50 with the same resin material I.

D50 of the fluororesin powder X is from 0.01 to 100 μm, preferably from 10 to 80 μm, more preferably from 20 to 50 μm. When D50 of the fluororesin powder X is at least the lower limit value of the above range, the coating film will be excellent in forming property. When D50 of the fluororesin powder X is at most the upper limit value of the above range, the coating film will be excellent in outer appearance.

The fluororesin powder X may be produced, for example, by the following method.
The fluororesin A is obtained by solution polymerization, suspension polymerization or emulsion polymerization, the organic solvent or the aqueous medium is removed to recover the fluororesin A in the form of particles, and as the case requires, the particles of the fluororesin A are ground, and as the case requires, the ground product is classified.
The fluororesin A, or as the case requires, the fluororesin A and other component, are melt-kneaded, the kneaded product is ground, and as the case requires, the ground product is classified.

### (Resin Powder Y)

The resin powder Y comprises a resin material II containing the resin B as the main component.

The resin material II containing the resin B as the main component means that the proportion of the resin B in the resin material II is at least 80 mass %. The proportion of the resin B to the resin material II is preferably at least 85 mass %, more preferably at least 90 mass %, particularly preferably 100 mass %. When the resin B is contained as the main component, the coating film will be excellent in abrasion resistance. Further, foaming of the coating film can be suppressed.

The resin B contained in the resin material II may be used in combination of two or more.

The resin material II preferably contains no fluororesin A. A resin material containing the fluororesin A and the resin B is likely to be fibrillated at the time of grinding, whereby a resin powder is hardly produced.

The resin material II may further contain, within a range not to impair the effects of the present invention, as the case requires, a component other than the resin B (excluding the fluororesin A).

The resin powder Y may be a powder containing two or more types of resin particles. For example, the resin powder Y may be a resin powder Y containing resin particles comprising a first resin material II and resin particles comprising a second resin material II different from the first resin material II. The first resin material II and the second resin material II are materials differing in the composition, for example, differing in the type of the resin B, differing in the content of the resin B, or differing in the component other than the resin B.

Further, the resin powder Y may contain two or more types of resin powders Y. For example, it may be a mixture of separately produced resin powders Y differing in D50 with the same resin material II.

D50 of the resin powder Y is from 0.01 to 100 μm, more preferably from 1 to 80 μm, furthermore preferably from 5 to 50 μm. When D50 of the resin powder Y is at least the lower limit value of the above range, the coating film will be excellent in abrasion resistance. Further, foaming of the coating film will be suppressed. When D50 of the resin powder Y is at most the upper limit value of the above range, the coating film will be excellent in outer appearance. Further, when D50 of the resin powder Y is smaller than D50 of the fluororesin powder X, such being preferred in view of surface smoothness.

The resin powder Y may be produced, for example, by the following method.
The resin B is obtained by solution polymerization, suspension polymerization or emulsion polymerization, the organic solvent or the aqueous medium is removed to recover the resin B in the form of particles, and as the case require, the particles of the resin B are ground, and as the case requires, the ground product is classified.
The resin B, or as the case requires, the resin B and other component, are melt-kneaded, the kneaded product is ground, and as the case requires, the ground product is classified.
The curable resin, or as the case requires, a mixture of the curable resin and other component is cured to form a cured product, which is ground, and as the case requires, the ground product is classified.

### (Other Powder)

Other powder which the powder composition may contain may, for example, be a fluororesin powder containing as the main component a fluororesin other than the fluororesin A, a non-fluororesin powder containing as the main component a non-fluororesin other than the resin B, a metal powder or an inorganic compound powder.

The powder composition may be obtained by mixing the fluororesin powder X and the resin powder Y. The mixing method may be a known method.

The temperature at the time of mixing is preferably a temperature lower than both the melting points of the fluororesin and the resin B. Within the above temperature range, the resins will not be dissolved at the time of mixing, and can be uniformly mixed.

### <Method for Producing Laminate>

The method for producing a laminate of the present invention is a method of applying the powder composition to the surface of the substrate thereby to form a coating film.

The coating method may, for example, be thermal spraying method, powder coating method or coating with a dispersion using a solvent, and in view of simplicity of the apparatus, preferably thermal spraying method or powder coating method, particularly preferably powder coating method.

The powder coating method may, for example, be electrostatic coating method, electrostatic spraying method, electrostatic dipping method, atomizing method, fluidized-bed coating method, rotational lining method, blasting method or spraying method, and in view of simplicity of the apparatus, preferably electrostatic coating method using a powder coating gun.

Firing may be conducted simultaneously with application of the powder composition or may be conducted after application of the powder composition, or application of the powder composition and firing may be conducted repeatedly.

The firing temperature is preferably at least the melting point of the fluororesin A, more preferably from 180 to 400° C., further preferably from 200 to 395° C., still more preferably from 320 to 390° C. By the firing temperature being at least the melting point of the fluororesin A, the coating film will be excellent in abrasion resistance.

Particularly, the firing temperature is preferably at least the melting point of the fluororesin A and at least the glass transition temperature or the melting point of the resin B, whereby the coating film will be excellent in outer appearance.

The firing time is preferably from 1 to 80 minutes, more preferably from 2 to 60 minutes.

The number of application and firing is preferably from 1 to 40 times, more preferably from 1 to 30 times, further preferably from 1 to 20 times.

In a case where firing is conducted several times, the firing time and the number of firing are properly selected depending upon the aimed thickness. For example, in a case where the thickness by single application is at a level of from 20 to 80 μm, the firing time is preferably from 1 to 20 minutes, preferably from 3 to 15 minutes.

It is also possible to form the coating film by applying or spraying the powder composition on the heated substrate, by immersing the heated substrate in the powder composition, or by rotational lining. On that occasion, the temperature of the substrate is more preferably from 180 to 400° C., further preferably from 200 to 395° C., still more preferably from 320 to 390° C.

After forming the coating film, annealing may be conducted, whereby abrasion resistance of the coating film may further be improved. The temperature at the time of annealing is preferably from 260 to 300° C., more preferably from 270 to 290° C. The time for annealing treatment is preferably from 1 to 48 hours, more preferably from 12 to 36 hours, further preferably from 20 to 30 hours.

### <Molded Product>

The molded product of the present invention contains the fluororesin A and the resin B. Further, the molded product may contain two or more types of the fluororesins A, and may contain two or more types of the resins B.

The molded product of the present invention may contain, within a range not to impair the effects of the present invention, as the case requires, a component other than the fluororesin A and the resin B.

The shape, the size, etc. of the molded product of the present invention are not particularly limited.

The proportion of the volume of the fluororesin A to the total of the volume of the fluororesin A and the volume of the resin B is from 99 to 1 vol %. When the proportion of the volume of the fluororesin A is at most 99 vol %, the molded product will be excellent in abrasion resistance. Further, foaming of the molded product will be suppressed. When the proportion of the volume of the fluororesin A is at least 1 vol %, properties of the molded product due to the fluororesin A will be sufficiently obtained.

The proportion of the volume of the fluororesin A in the molded product to the total of the volume of the fluororesin A and the volume of the resin B is preferably from 99 to 51 vol %, more preferably from 99 to 60 vol %, further preferably from 99 to 70 vol %. When the proportion of the volume of the fluororesin A is at most the upper limit value of the above range, the molded product will be excellent in abrasion resistance. When the proportion of the volume of the fluororesin A is at least the lower limit value of the above range, properties of the molded product due to the fluororesin A, such as low friction property and chemical resistance, will be sufficiently obtained.

In a case where properties of the molded product due to the resin B, such as abrasion resistance, are to be sufficiently obtained, the proportion of the volume of the fluororesin A to the total of the volume of the fluororesin A and the volume of the resin B is preferably from 1 to 51 vol %, more preferably from 1 to 40 vol %, further preferably from 1 to 30 vol %.

The total of the volume of the fluororesin A and the volume of the resin B to the volume of the molded product is at least 80 vol %, more preferably at least 85 vol %, further preferably at least 90 vol %. When the total of the volume of the fluororesin A and the volume of the resin B is at least the lower limit value of the above range, the molded product will be excellent in abrasion resistance while properties of the molded product due to the fluororesin A will be sufficiently obtained.

In a case where the proportion of the volume of the fluororesin in the molded product to the total of the volume of the fluororesin A and the volume of the resin B is from 99 to 60 vol %, the average dispersed particle size of the resin B dispersed in the molded product is from 10 to 100 μm, preferably from 15 to 100 μm, more preferably from 20 to 100 μm. In such a case, the proportion of the volume of the fluororesin is preferably from 99 to 70 vol %. When the average dispersed particle size of the resin B is at least the lower limit value of the above range, the molded product will be excellent in abrasion resistance. When the average dispersed particle size of the resin B is at most the upper limit value of the above range, the molded product will be excellent in outer appearance.

Further, when the proportion of the volume of the resin B in the molded product to the total of the volume of the fluororesin A and the volume of the resin B is from 99 to 60 vol %, the average dispersed particle size of the fluororesin A dispersed in the molded product is from 10 to 100 μm, preferably from 15 to 100 μm, more preferably from 20 to 100 μm. In such a case, the proportion of the volume of the resin B is more preferably from 99 to 70 vol %. When the average dispersed particle size of the fluororesin A is at least the lower limit value of the above range, the molded product will be excellent in outer appearance. When the average dispersed particle size of the fluororesin A is at most the upper limit value of the above range, the molded product will be excellent in abrasion resistance.

### <Method for Producing Molded Product>

The method for producing a molded product of the present invention is a method of compression-molding the powder composition.

As the compression-molding method, a method of putting the powder composition in a cavity of a mold, and pressurizing the powder composition by the mold while heating the mold may be mentioned.

The heating temperature is preferably at least the melting point of the fluororesin A, more preferably from 180 to 400° C., further preferably from 200 to 360° C.

The pressure is preferably from 1 to 50 Pa, more preferably from 5 to 20 Pa.

The pressurizing time is preferably from 1 to 80 minutes, more preferably from 2 to 60 minutes.

### EXAMPLES

Now, the present invention will be described in further detail with reference to Examples, however, it should be understood that the present invention is by no means restricted thereto.

Ex. 2, 3, 5, 6, 8 to 13, 15 to 18, 20 to 24 and 26 to 43 are Examples of the present invention, and Ex. 1, 4, 7, 14, 19, 25 and 44 are Comparative Examples.

### (Proportion of Units in Fluorinated Copolymer)

The proportion of NAH units was obtained by infrared absorption spectrum analysis. The proportions of units other than the NAH units were obtained by melt NMR analysis and fluorine content analysis.

### (Infrared Absorption Spectrum Analysis)

The fluorinated copolymer was pressed to obtain a film having a thickness of 200 μm. The film was analyzed by infrared spectrometry to obtain an infrared absorption spectrum. In the infrared absorption spectrum, the absorption peak of NAH units in the fluorinated copolymer appears at 1,778 cm⁻¹. The absorbance of the absorption peak was measured, and by means of the molar absorption coefficient of NAH of 20,810 mol⁻¹·L·cm⁻¹, the proportion of the NAH units in the fluorinated copolymer was obtained.

### (Melting Point)

Using a differential scanning calorimeter (manufactured by Seiko Instruments Inc, DSC-7020), the melting peak when the fluorinated copolymer was heated at a rate of 10° C./min was recorded, and the temperature (° C.) corresponding to the maximum value was taken as the melting point.

### (MFR)

Using a melt indexer (manufactured by TECHNOL SEVEN CO., LTD.), the mass (g) of the fluorinated copolymer which flowed out in 10 minutes from a nozzle having a diameter of 2 mm and a length of 8 mm at 372° C. under a load of 49N was measured and taken as MFR.

### (D50 of Fluorinated Copolymer)

A 2.000 mesh sieve (aperture: 2.400 mm), a 1.410 mesh sieve (aperture: 1.705 mm), a 1.000 mesh sieve (aperture: 1.205 mm), a 0.710 mesh sieve (aperture: 0.855 mm), a 0.500 mesh sieve (aperture: 0.605 mm), a 0.250 mesh sieve (aperture: 0.375 mm), a 0.149 mesh sieve (aperture: 0.100 mm) and a drip pan were overlaid in order from above. The fluorinated copolymer was put on the top sieve, followed by sieving by a shaker for 30 minutes. The mass of the fluorinated copolymer remaining on each sieve was measured, and the cumulative mass of the fluorinated copolymer passing each aperture was plotted on a graph, and the particle size at which the cumulative mass of the copolymer passing the aperture was 50% was taken as D50 of the fluorinated copolymer.

### (D50 of Resin Powder)

Using a laser diffraction/scattering particle size distribution measuring apparatus (manufactured by HORIBA, Ltd., LA-920), a resin powder was dispersed in water, the particle size distribution was measured, and D50 of the resin powder was calculated.

### (Average Dispersed Particle Size of Resin Particles)

Measured in accordance with the method for measuring “average dispersed particle size” of resin particles dispersed in the coating film of the laminate and the molded product.

### (Outer Appearance of Coating Film)

The coating film of the laminate was visually observed and evaluated based on the following standards.

◯ (good): No foaming observed in the coating film

× (poor): Foaming observed in the coating film.

### (Abrasion Resistance Test 1)

With respect to a coating film of a test sample, abrasion test was conducted using a Taber abrasion tester (manufactured by YASUDA SEIKI SEISAKUSHO, LTD., Taber Type Abrasion Tester), under conditions of abrasion wheel: H22, load: 1,000 g (9.8N), number of revolutions: 60 revolutions/min, temperature: 23° C., humidity: 50% RH. The mass change of the coating film after 1,000 revolutions was measured, which was calculated to volume and taken as the abrasion amount of the coating film (abrasion amount 1).

### (Abrasion Resistance Test 2, Coefficient of Dynamic Friction)

With respect to a coating film of a test specimen, test was conducted by Matsubara abrasion measurement method (circular flat surface type, 0-ring type) in accordance with JIS K-7218 using an abrasion tester manufactured by ORIENTEC CORPORATION. At room temperature, a ring (material: S45Cs (1.5S), contact area: 2 cm²) as a mating object was brought into contact with a test specimen under a pressure of 0.69 MPa at a rotational speed of 0.5 m/sec for a test time of 30 minutes, and the abrasion amount of the test specimen (abrasion amount 2) and coefficient of dynamic friction were measured.

The abrasion resistance test 1 and the abrasion resistance test 2 are selected depending upon the application assumed. In Examples of the present invention and Comparative Examples, the abrasion resistance test 2 is preferred, whereby the tendency of the abrasion resistance is likely to be obtained.

### (Surface Smoothness)

With respect to the coating film of a test specimen, surface smoothness (Ra) was measured by using surface roughness measuring instrument SE-30H manufactured by Kosaka Laboratory Ltd.

### (Peel Strength Measurement)

With respect to the coating film of a test specimen, on its surface, notches were made at 10 mm intervals by a cutter knife, a part of the coating film layer was peeled and fixed to a chuck of a tensile tester (manufactured by A&D Company, Limited, TENSILON UTM4L), and peeled 90 degrees at a rate of pulling of 50 mm/min, whereupon the peel strength (N/cm) was measured.

### (Fluororesin A)

Fluorinated copolymer (A1-1) was produced in accordance with WO2016/017801.

The proportion of the respective units in the fluorinated copolymer (A1-1) was NAH units/TFE units/PPVE units=0.1/97.9/2.0 (mol %). The fluorinated copolymer (A1-1) had a melting point of 300° C., a specific gravity of 2.13 and MFR of 17.6 g/10 min. The fluorinated copolymer (A1-1) had D50 of 1,554 μm.

### (Fluororesin Powder X)

The fluorinated copolymer (A1-1) in the form of particles was ground by a rotor mill (manufactured by FRITSCH, rotor speed mill P-14) at a number of revolutions of 1,300 rpm. The obtained ground product was subjected to sieving, and one which had passed a sieve with a size of 0.5 mm was recovered and taken as fluororesin powder X-1. The fluororesin powder (X-1) had D50 of 22.08 μm and a specific gravity of 2.13.

### (Resin Powder Y)

Resin powder (Y-1): manufactured by Victrex PLC, PEEK 150FP, D50: 50 μm, specific gravity: 1.3.

Resin powder (Y-2): manufactured by Daicel-Evonik Ltd., PEEK, VESTAKEEP 2000 UFP20, D50: 20 μm, specific gravity: 1.3.

Resin powder (Y-3): manufactured by SUMITOMO CHEMICAL COMPANY, LIMITED, PES SUMIKAEXCEL 5003MP, D50: 45 μm, specific gravity: 1.37.

Resin powder (Y-4): manufactured by SUMITOMO CHEMICAL COMPANY, LIMITED, PES SUMIKAEXCEL 4100MP, D50: 25 μm, specific gravity: 1.37.

Resin powder (Y-5): manufactured by Solvay, PPS Ryton V-1, D50:30 μm, specific gravity: 1.35.

Resin powder (Y-6): manufactured by SABIC, PEI ULTEM1000F3SP-1000, D50: 50 μm, specific gravity: 1.27.

Resin powder (Y-7):

PEKK resin KEPSTAN 6002 manufactured by ARKEMA was ground by freezer mill TPH-01 manufactured by AS ONE CORPORATION to obtain resin powder (Y-7) comprising PEKK. The resin powder (Y-7) had D50 of 34 μm and a specific gravity of 1.27.

### (Ex. 2 and 3)

The fluororesin powder X was weighed in a plastic bag with a fastener, and then the resin powder Y was weighed, in the blend ratio (vol %) as identified in Table 1, and preliminarily mixed. To calculate the blend ratio (vol %), the above specific gravity was employed.

The whole content was put in a juicer mixer and stirred at 25° C. for 30 seconds to obtain a powder composition.

On the surface of an aluminum plate (JIS A 5052) of 125 mm×125 mm×1 mm in thickness, the powder composition was applied by electrostatic coating by a corona discharge powder electrostatic coating machine (manufactured by ASAHI SUNAC CORPORATION, XR3-100DFM). The aluminum plate with the powder composition was suspended in a precision hot air constant temperature oven (manufactured by Tojonetsugaku K.K.) and fired at 330° C. for 10 minutes. Electrostatic coating and firing were repeated 5 times to obtain a test specimen having a thickness of 300 μm. The outer appearance of the coating film and the results of the abrasion resistance test 1 (abrasion amount 1) are shown in Table 1.

### (Ex. 5, 6, 8 and 9)

Test specimens were obtained in the same manner as in Ex. 2 and 3 except that the firing temperature was changed. The outer appearance of the coating film and the results of the abrasion resistance test 1 are shown in Table 1.

### (Ex. 1, 4 and 7)

Test specimens were obtained in the same manner as in Ex. 2, 5 and 8 except that only the fluororesin powder (X-1) was used instead of the powder composition. The outer appearance of the coating film and the results of the abrasion resistance test are shown in Table 1.

TABLE 1

| | | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|---|
| Blend | Fluororesin powder (X-1) | 100 | 95 | 90 | 100 | 95 | 90 | 100 | 95 | 90 |
| ratio | Resin powder (Y-1) | 0 | 5 | 10 | 0 | 5 | 10 | 0 | 5 | 10 |
| (vol %) | | | | | | | | | | |

| | | | | | | | | | |
|---|---|---|---|---|---|---|---|---|---|
| Firing temperature (° C.) | 330 | 330 | 330 | 350 | 350 | 350 | 360 | 360 | 360 |
| Outer appearance of coating film | ∘ | ∘ | ∘ | x | ∘ | ∘ | x | ∘ | ∘ |
| Abrasion amount of coating film | 14.2 | 8.2 | 6.2 | Unmeasurable | 5.9 | 7.3 | Unmeasurable | 4.9 | 5.8 |
| (mm³) (abrasion amount 1) | | | | | | | | | |
| Average dispersed particle size of | — | 44 | 46 | — | 42 | 44 | — | 40 | 43 |
| resin B (μm) | | | | | | | | | |

### (Ex. 10 to 12)

Test specimens were obtained in the same manner as in Ex. 2 and 3 except that the resin powder (Y-2) or (Y-3) was used. The outer appearance of the coating film and the results of the abrasion resistance test 1 are shown in Table 2.

### (Ex. 13)

The test specimen prepared in Ex. 12 was left at rest in a circulating hot air oven MKO-825 manufactured by Maruya Kanagawa Seisakusho and subjected to annealing at 285° C. for 24 hours. The outer appearance of the obtained test specimen and the results of the abrasion resistance test 1 are shown in Table 2.

TABLE 2

| | | Ex. 10 | Ex. 11 | Ex. 12 | Ex. 13 |
|---|---|---|---|---|---|
| Blend | Fluororesin powder (X-1) | 95 | 90 | 95 | 95 |
| ratio | Resin powder (Y-2) | 5 | 10 | — | — |
| (vol %) | Resin powder (Y-3) | — | — | 5 | 5 |

| | | | | |
|---|---|---|---|---|
| Firing temperature (° C.) | 330 | 330 | 330 | 330 |
| Annealing (° C.) | Nil | Nil | Nil | 285 |
| Outer appearance of coating film | ∘ | ∘ | ∘ | ∘ |
| Abrasion amount of coating film (mm³) | 3.9 | 4.4 | 3.6 | 3.4 |
| (abrasion amount 1) | | | | |
| Average dispersed particle size of | 18 | 17 | 40 | 42 |
| resin B (μm) | | | | |

### (Ex. 14 to 18)

Test specimens were prepared in the same manner as in Ex. 1 and Ex. 2, and the abrasion amount (abrasion amount 2) and the coefficient of dynamic friction were measured in the abrasion resistance test 2, and the surface smoothness was measured. The results are shown in Table 3.

TABLE 3

| | | Ex. 14 | Ex. 15 | Ex. 16 | Ex. 17 | Ex. 18 |
|---|---|---|---|---|---|---|
| Blend | Fluororesin powder (X-1) | 100 | 95 | 90 | 95 | 90 |
| ratio | Resin powder (Y-3) | — | 5 | 10 | — | — |
| (vol %) | Resin powder (Y-4) | — | — | — | 5 | 10 |

| | | | | | |
|---|---|---|---|---|---|
| Firing temperature (° C.) | 330 | 330 | 330 | 330 | 330 |
| Abrasion amount of coating film (mm³) | 0.021 | 0.009 | 0.006 | 0.008 | 0.005 |
| (abrasion amount 2) | | | | | |
| Surface smoothness of coating film Ra | 1.0 | 2.9 | 4.0 | 1.0 | 1.2 |
| (μm) | | | | | |
| Coefficient of dynamic friction | 0.36 | 0.33 | 0.32 | 0.32 | 0.32 |
| Average dispersed particle size of | — | 40 | 42 | 22 | 20 |
| resin B (μm) | | | | | |

### (Ex. 19 to 21)

The surface of a SUS304 stainless steel plate of 40 mm×150 mm×2 mm in thickness was sand-blasted with 60 mesh alumina particles to a surface roughness Ra to be from 5 to 10 μm, and cleaned with ethanol to prepare a substrate. The fluororesin powder (X-1) and the resin powder (Y-2) were mixed in a proportion as identified in Table 3 to obtain a powder composition. The powder composition was applied to the substrate by electrostatic coating by a corona discharge powder electrostatic coating machine (manufactured by ASAHI SUNAC CORPORATION, XR3-100DFM). The substrate with the powder composition was suspended in a precision hot air constant temperature oven (manufactured by Tojonetsugaku K.K.) and fired at 340° C. for 6 minutes in Ex. 19 or at 360° C. for 6 minutes in Ex 20 and 21. Electrostatic coating and firing were repeated 5 times to obtain a test specimen. The peel strength of the obtained test specimen was measured. The results are shown in Table 4.

TABLE 4

| | | Ex. 19 | Ex. 20 | Ex. 21 |
|---|---|---|---|---|
| Blend ratio | Fluororesin powder (X-1) | 100 | 95 | 90 |
| (vol %) | Resin powder (Y-2) | — | 5 | 10 |

| | | | |
|---|---|---|---|
| Firing temperature (° C.) | 340 | 360 | 360 |
| Peel strength (N/cm) | 13.8 | 16.5 | 18.6 |
| Average dispersed particle size of | — | 14 | 16 |
| resin B (μm) | | | |

### (Ex. 22 to 24)

Test specimens were prepared in the same manner as in Ex. 2 in a blend ratio as identified in Table 5, and the abrasion amount 2 and the coefficient of dynamic friction were measured. The results are shown in Table 5.

### (Ex. 25 and 26)

Test specimens were prepared in the same manner as in Ex. 2 except that the firing temperature was 360° C., in a blend ratio as identified in Table 5, and the abrasion amount 2 and the coefficient of dynamic friction were measured. The results are shown in Table 5.

TABLE 5

| | | Ex. 22 | Ex. 23 | Ex. 24 | Ex. 25 | Ex. 26 |
|---|---|---|---|---|---|---|
| Blend | Fluororesin powder (X-1) | 95 | 90 | 80 | — | 5 |
| ratio | Resin powder (Y-1) | — | — | — | 100 | 95 |
| (vol %) | Resin powder (Y-2) | 5 | 10 | 20 | — | — |

| | | | | | |
|---|---|---|---|---|---|
| Firing temperature (° C.) | 330 | 330 | 330 | 360 | 360 |
| Abrasion amount of coating film | 0.0004 | 0.0003 | 0.0002 | 0.0007 | 0.0002 |
| (mm³) (abrasion amount 2) | | | | | |
| Coefficient of dynamic friction | 0.26 | 0.27 | 0.27 | 0.65 | 0.22 |
| Average dispersed particle size of | — | — | — | — | 16 |
| fluororesin A (μm) | | | | | |

### (Ex. 27 and 28)

Substrates were prepared in the same manner as in Ex. 19 to 21. The fluororesin powder (X-1) and the resin powder (Y-2) were mixed in a blend ratio as shown in Table 6 to obtain powder compositions. The powder composition was applied to the substrate by electrostatic coating as a first layer by a corona discharge powder electrostatic coating machine (manufactured by ASAHI SUNAC CORPORATION, XR3-100DFM). The substrate with the powder composition was suspended in a precision hot air constant temperature oven (manufactured by Tojonetsugaku K.K.) and fired at 340° C. for 10 minutes. Then, the fluororesin powder (X-1) or commercial fluororesin powder MP-102 (manufactured by Dupont) was similarly applied by electrostatic coating as a second layer, and the substrate was fired at 340° C. for 5 minutes. Electrostatic coating and firing of the second layer were repeated three times to obtain a test specimen. The test specimen had a structure of stainless steel plate/first layer/second layer. The peel strength between the stainless steel plate and the first layer of the obtained test specimen was measured. The results are shown in table 6.

TABLE 6

| | | Ex. 27 | Ex. 28 |
|---|---|---|---|
| Blend ratio | Fluororesin powder | 80 | 80 |
| (vol %) | (X-1) | | |
| first layer | Resin powder (Y-2) | 20 | 20 |
| Blend ratio | Fluororesin powder | 100 | — |
| (vol %) | (X-1) | | |
| second layer | MP-102 | — | 100 |

| | | |
|---|---|---|
| Peel strength (N/cm) | Material failure | Material failure |

### (Ex. 29 to 32)

Substrates were prepared in the same manner as in Ex. 19 to 21. The fluororesin powder (X-1) and the resin powder (Y-5) or (Y-6) were mixed in a blend ratio as identified in Table 7 to obtain powder compositions. Test specimens were obtained in the same manner as in Ex. 19 to 21 except that the firing temperature and time and the number of coating were as identified in Table 7. With respect to each test specimen, the appearance of the coating film and the peel strength were measured. The results are shown in Table 7.

TABLE 7

| | | Ex. 29 | Ex. 30 | Ex. 31 | Ex. 32 |
|---|---|---|---|---|---|
| Blend | Fluororesin powder (X-1) | 80 | 80 | 80 | 80 |
| ratio | Resin powder (Y-5) | 20 | — | — | — |
| (vol %) | Resin powder (Y-6) | — | 20 | 20 | 20 |

| | | | | |
|---|---|---|---|---|
| Firing temperature (° C.) | 360 | 340 | 350 | 360 |
| Firing time (min) | 5 | 15 | 15 | 15 |
| Number of coating (coating + firing) | 12 | 4 | 4 | 3 |
| Peel strength (N/cm) | 53 | 31 | 23 | 27 |
| Outer appearance of coating film | ∘ | ∘ | ∘ | ∘ |
| Average dispersed particle size of | 25 | 43 | 41 | 40 |
| resin B (μm) | | | | |

### (Ex. 33 to 35)

Substrates were prepared in the same manner as in Ex. 19 to 21. The fluororesin powder (X-1) and the resin powder (Y-7) were mixed in a blend ratio as identified in Table 8 to obtain powder compositions. Test specimens were obtained in the same manner as in Ex. 19 to 21 except that the firing temperature and time and the number of coating were as identified in Table 8. With respect to each test specimen, the outer appearance of the coating film and the peel strength were measured. The results are shown in Table 8.

TABLE 8

| | | Ex. 33 | Ex. 34 | Ex. 35 |
|---|---|---|---|---|
| Blend ratio | Fluororesin powder (X-1) | 80 | 80 | 80 |
| (vol %) | Resin powder (Y-7) | 20 | 20 | 20 |

| | | | |
|---|---|---|---|
| Firing temperature (° C.) | 340 | 350 | 360 |
| Firing time (min) | 15 | 15 | 5 |
| Number of coating (coating + firing) | 4 | 4 | 8 |
| Peel strength (N/cm) | 37 | 24 | 43 |
| Outer appearance of coating film | ∘ | ∘ | ∘ |
| Average dispersed particle size of | 30 | 28 | 27 |
| resin B (μm) | | | |

### (Ex. 37 to 43)

Test specimens were prepared in the same manner as in Ex. 2 except that the firing temperature was 340° C., in a blend ratio as identified in Table 9, and the abrasion amount 2 and the coefficient of dynamic friction were measured. The results are shown in Table 9.

TABLE 9

| | | Ex. 36 | Ex. 37 | Ex. 38 | Ex. 39 | Ex. 40 | Ex. 41 | Ex. 42 | Ex. 43 |
|---|---|---|---|---|---|---|---|---|---|
| Blend | Fluororesin powder (X-1) | 95 | 90 | 80 | 95 | 90 | 80 | 10 | 20 |
| ratio | Resin powder (Y-6) | 5 | 10 | 20 | — | — | — | 90 | 80 |
| (vol %) | Resin powder (Y-7) | — | — | — | 5 | 10 | 20 | — | — |

| | | | | | | | | |
|---|---|---|---|---|---|---|---|---|
| Firing temperature (° C.) | 340 | 340 | 340 | 340 | 340 | 340 | 340 | 340 |
| Abrasion amount of coating film | 0.0015 | 0.0009 | 0.0006 | 0.0036 | 0.0025 | 0.0012 | 0.0013 | 0.0007 |
| (mm³) (abrasion amount 2) | | | | | | | | |
| Coefficient of dynamic friction | 0.34 | 0.29 | 0.27 | 0.38 | 0.33 | 0.3 | 0.27 | 0.28 |
| Average dispersed particle size of | — | — | — | — | — | — | 20 | 21 |
| fluororesin A (μm) | | | | | | | | |

### (Ex. 44)

Epoxy resin 1007 manufactured by Mitsubishi Chemical Corporation, which is an uncured epoxy resin, was freeze-ground to obtain a powder comprising an epoxy resin having an average particle size of 28 μm.

A powder composition was obtained in the same manner as in Ex. 2 except that the powder comprising an epoxy resin was used instead of the resin powder (Y-1) in Ex. 2. A coating film was formed in the same manner as in Ex. 2 using the powder composition. The abrasion amount of the coating film (mm³) (abrasion amount 1) was 14.2, and no improvement in the abrasion resistance as compared with Ex. 1 was observed.

It was found from Table 1 that in Ex. 1 in which no resin powder Y was contained, the abrasion resistance was low, and in Ex. 4 and 7, foaming was observed in the coating film and the abrasion resistance could not even measured. Whereas in Ex. 2, 3, 5, 6, 8 and 9, both the outer appearance of the coating film and the abrasion resistance were excellent.

As evident from Table 2, it is found from comparison between Ex. 12 and 13, the abrasion resistance further improved by the annealing treatment.

It was confirmed from Tables 3 and 9 that the effects to improve the abrasion resistance and to improve low friction properties unchanged even when the type of the resin B was changed.

Further, it was found from Ex. 15 to 18 in Table 3 that the surface smoothness was more excellent when D50 of the resin powder Y was smaller.

It was found from Table 4 that in Ex. 19 in which no resin B was contained, the peel strength was low, and the adhesion was low, as compared with Ex. 20 and 21 in which the resin B was contained.

Further, it was also found that the adhesion more increased as the amount of the resin B was increased.

It was found from Table 5 that in Ex. 25 in which no fluororesin A was contained, the coefficient of dynamic friction was high and low friction property was poor, and in addition, the abrasion resistance was also poor as compared with Ex. 22 to 24 and 26 in which the fluororesin A was contained.

It was found from Table 6 that the coating film in the laminate of the present invention had favorable adhesion to the substrate even when a second layer was provided on the coating film.

It was found from Tables 7 and 8 that a laminate with high peel strength and excellent adhesion was obtained even when the firing conditions were changed.

### INDUSTRIAL APPLICABILITY

The laminate obtained by the production method of the present invention is useful as an exterior member for building (aluminum composite panel, aluminum panel for curtain wall, aluminum frame for curtain wall, aluminum window frame), a member for semiconductor production process, a member for food production process, a sleeve component (a sleeve component for transport such as an automobile or an aircraft, a sleeve member for home appliance, a sleeve member for industrial machine), a bearing member, a heat exchanger, etc.

This application is a continuation of PCT Application No. PCT/JP2019/006612, filed on Feb. 21, 2019, which is based upon and claims the benefit of priority from Japanese Patent Application No. 2018-030922 filed on Feb. 23, 2018, Japanese Patent Application No. 2018-102664 filed on May 29, 2018 and Japanese Patent Application No. 2018-166293 filed on Sep. 5, 2018. The contents of those applications are incorporated herein by reference in their entireties.

### REFERENCE SYMBOLS

10: laminate,

12: substrate,

14: coating film.

What is claimed is:

1. A method for producing a laminate comprising a substrate and a coating film formed on a surface of the substrate, which comprises applying the following powder composition on the surface of the substrate to form the coating film:
powder composition:
a powder composition comprising a fluororesin powder formed of a resin material containing the following fluororesin as the main component and having D50 of from 0.01 to 100 μm, and
a non-fluororesin powder formed of a resin material containing the following non-fluororesin as the main component and having D50 of from 0.01 to 100 μm,
wherein the proportion of the volume of the fluororesin powder to the total of the volume of the fluororesin powder and the volume of the non-fluororesin powder is from 99 to 1 vol %, and
the total of the volume of the fluororesin powder and the volume of the non-fluororesin powder to the volume of the powder composition is at least 80 vol %;
fluororesin:
a melt-moldable fluororesin having at least one type of functional group selected from the group consisting of a carbonyl group-containing group, a hydroxy group, an epoxy group, an amide group, an amino group and an isocyanate group;
non-fluororesin:
a resin selected from the group consisting of a polyarylketone, a thermoplastic polyimide, a polyamideimide, a polyetherimide, a polyarylene sulfide, a polyarylate, a polysulfone, a polyethersulfone, a liquid crystal polymer, and a cured product of a curable resin.

2. The method for producing a laminate according to claim 1, wherein D50 of the fluororesin powder is from 10 to 80 μm, and D50 of the non-fluororesin powder is from 1 to 80 μm.

3. The method for producing a laminate according to claim 1, wherein the substrate is made of a metal.

4. The method for producing a laminate according to claim 1, wherein the powder composition is applied to the surface of the substrate by thermal spraying method or powder coating method.

5. The method for producing a laminate according to claim 1, wherein the proportion of the volume of the fluororesin powder to the total of the volume of the fluororesin powder and the volume of the non-fluororesin powder is from 99 to 51 vol %, and the melting point of the fluororesin is from 260 to 320° C.

6. A laminate comprising a substrate and a coating film formed on the surface of the substrate,
wherein the coating film contains the following fluororesin and the following non-fluororesin,
the proportion of the volume of the fluororesin to the total of the volume of the fluororesin and the volume of the non-fluororesin is from 99 to 1 vol %, and
the total of the volume of the fluororesin and the volume of the non-fluororesin to the volume of the coating film is at least 80 vol %,
fluororesin:
a melt-moldable fluororesin having at least one type of functional group selected from the group consisting of a carbonyl group-containing group, a hydroxy group, an epoxy group, an amide group, an amino group and an isocyanate group;
non-fluororesin:
a resin selected from the group consisting of a polyarylketone, a thermoplastic polyimide, a polyamideimide, a polyetherimide, a polyarylene sulfide, a polyarylate, a polysulfone, a polyethersulfone, a liquid crystal polymer, and a cured product of a curable resin.

7. The laminate according to claim 6, wherein the substrate is made of a metal.

8. The laminate according to claim 6, wherein the proportion of the volume of the fluororesin to the total of the volume of the fluororesin and the volume of the non-fluororesin is from 99 to 51 vol %, and the melting point of the fluororesin is from 260 to 320° C.

9. The laminate according to claim 6, wherein the proportion of one of the volume of the fluororesin and the volume of the non-fluororesin to the total of the volume of the resins is from 99 to 60 vol %; in the resin with a higher volume proportion, the other resin is dispersed as particles; and the average dispersed particle size of said other resin is from 10 to 100 μm.

10. A method for producing a molded product, which comprises compression-molding the following powder composition:
powder composition:
a powder composition comprising a fluororesin powder formed of a resin material containing the following fluororesin as the main component and having D50 of from 0.01 to 100 μm, and
a non-fluororesin powder formed of a resin material containing the following non-fluororesin as the main component and having D50 of from 0.01 to 100 μm,
wherein the proportion of the volume of the fluororesin powder to the total of the volume of the fluororesin powder and the volume of the non-fluororesin powder is from 99 to 1 vol %, and
the total of the volume of the fluororesin powder and the volume of the non-fluororesin powder to the volume of the powder composition is at least 80 vol %;
fluororesin:
a melt-moldable fluororesin having at least one type of functional group selected from the group consisting of a carbonyl group-containing group, a hydroxy group, an epoxy group, an amide group, an amino group and an isocyanate group;
non-fluororesin:
a resin selected from the group consisting of a polyarylketone, a thermoplastic polyimide, a polyamideimide, a polyetherimide, a polyarylene sulfide, a polyarylate, a polysulfone, a polyethersulfone, a liquid crystal polymer, and a cured product of a curable resin.

11. The method for producing a molded product according to claim 10, wherein D50 of the fluororesin powder is from 10 to 80 μm, and D50 of the non-fluororesin powder is from 1 to 80 μm.

12. The method for producing a molded product according to claim 10, wherein the proportion of the volume of the fluororesin powder to the total of the volume of the fluororesin powder and the volume of the non-fluororesin powder is from 99 to 51 vol %, and the melting point of the fluororesin is from 260 to 320° C.

13. A molded product containing the following fluororesin and the following non-fluororesin,
wherein the proportion of the volume of the fluororesin to the total of the volume of the fluororesin and the volume of the non-fluororesin is from 99 to 1 vol %, and
the total of the volume of the fluororesin and the volume of the non-fluororesin to the volume of the molded product is at least 80 vol %;
fluororesin:
a melt-moldable fluororesin having at least one type of functional group selected from the group consisting of a carbonyl group-containing group, a hydroxy group, an epoxy group, an amide group, an amino group and an isocyanate group;
non-fluororesin:
a resin selected from the group consisting of a polyarylketone, a thermoplastic polyimide, a polyamideimide, a polyetherimide, a polyarylene sulfide, a polyarylate, a polysulfone, a polyethersulfone, a liquid crystal polymer, and a cured product of a curable resin.

14. The molded product according to claim 13, wherein the proportion of the volume of the fluororesin to the total of the volume of the fluororesin and the volume of the non-fluororesin is from 99 to 51 vol %, and the melting point of the fluororesin is from 260 to 320° C.

15. The molded product according to claim 13, wherein the proportion of one of the volume of the fluororesin and the volume of the non-fluororesin to the total of the volumes of the resins is from 99 to 60 vol %; in the resin with a higher volume proportion, the other resin is dispersed as particles; and the average dispersed particle size of said other resin is from 10 to 100 μm.
